(19) United States
(12) Patent Application Publication
(10) Pub. No.: US 2004/0013596 A1
(43) Pub. Date: Jan. 22, 2004

(54) Ppc production

(76) Inventors: Pierre M Fouche, Boksburg (ZA); Paul Stuiver, Randburg (ZA); Jeremy M Gaylard, Edenvale (ZA)

Correspondence Address: NIXON & VANDERHYE, PC, 1100 N GLEBE ROAD, 8TH FLOOR, ARLINGTON, VA, 22201-4714, US

(21) Appl. No.: 10/381,140

(22) PCT Filed: Sep. 20, 2001
(86) PCT No.: PCT/ZA01/00149

(30) Foreign Application Priority Data
Sep. 21, 2000 (ZA) 2000/5054

(51) Int. Cl. C01F 11/18

(52) U.S. Cl. 423/432

(57) ABSTRACT

The present invention provides a method of reducing the detrimental environmental impact of an industrial plant which produced or produces a product selected from the group consisting of calcium oxide, also known as lime, and carbon dioxide gas, the method comprising the step of forming an environmentally less detrimental composition from such product which composition comprises predominantly calcium carbonate.

### FIELD OF THE INVENTION

This invention relates to a method aimed at the reduction of the detrimental environmental impact of industrial processes producing calcium oxide, also known as lime, and/or carbon dioxide as by-products. The method in essence involves the production of relatively inert and hence environmentally neutral calcium carbonate from such by-product calcium oxide which, as is explained in greater detail below, is relatively reactive. While the invention employs a series of procedures, none of which is are new in their own right, the unique combination of the invention creates a composite procedure which, now for the first time, allows the known individual chemical and physical procedures to be offered for application in addressing the problem associated with waste calcium oxide production. Moreover, it allows for this in a manner which is not only economically feasible, but which in fact may, under certain circumstances, be more than merely self funding, and capable of producing a net profit. The invention is specifically, though not exclusively, aimed at the production of calcium carbonate from a source of calcium oxide and carbon dioxide which often present an environmental challenge at the same site. The calcium oxide may, for example, be in the form of dust collected in gas cleaning equipment associated with plants used in the production of lime by the calcining of limestone which process gives rise to fine calcium oxide powder entrained in a gaseous stream which also contains carbon dioxide. If solid fuel is used for kiln firing the gaseous stream will also contain fuel ash. Carbon dioxide is also produced during the calcining of the limestone and is at present simply discharged into the atmosphere after separation of the solid dust particles, or at least the bulk of it, therefrom.

### BACKGROUND TO THE INVENTION

Lime or calcium oxide (CaO) is conventionally produced by calcining limestone or calcium carbonate (CaCO₃) at high temperature in kilns of various configurations. Coal, gas or oil is used as fuel to achieve a peak temperature in excess of 1100° C. in the kiln. During the conversion of calcium carbonate into lime carbon dioxide is emitted as the limestone progresses through the kiln.

The harsh temperature conditions in the kiln and the movement of the kiln and/or limestone give rise to the break-up of the decomposing limestone and the associated production of large quantities of dust which contains calcium oxide, fuel residues, metallic oxides (typically iron-, manganese- and magnesium oxides) and non-metallic oxides (such as silica). The exact composition of the dust depends on the composition of the feedstock limestone and of the fuel utilised in the process. Such dust is entrained in a gas stream which exhausts from the kiln. This gas stream is rich in carbon dioxide originating from two sources, namely as a combustion product of the fuel utilised and as a by-product of the calcination of calcium carbonate into calcium oxide.

Dust which is rich in calcium oxide and carbon dioxide is also produced as by-products in other types of lime kiln systems, and in other industrial processes such as plants producing burnt dolomite.

In the days before environmental consciousness the dust generated during, for example, lime production and entrained in the waste gas stream was simply discharged into the atmosphere through exhaust flue columns or chimneys along with the gas. The billowing clouds of dust or “smoke” emitted from the “smoke-stacks” was typical of lime producing factories in those days. Modern lime producing factories are fitted with a variety of dust removal equipment which, to a very large degree, now separate the solid particles from the gas stream so that the flue emissions from lime factories now comprise substantially, or at least relatively dust free gas composed mainly of carbon dioxide and nitrogen, and other gaseous combustion products depending on the fuel used.

It is well known that the steps required to be taken to render a production process more environmentally friendly inevitably call for the expenditure of large sums of capital and operational costs which naturally reduce the profitability of the process. It is no different in the production of lime. The removal of the dust from the exhaust gas adds substantially to the cost of production of the saleable lime produced.

Despite the vast environmental improvement brought about by the removal of dust from the gas stream discharged into the atmosphere as described above, it does not present a complete environmental solution.

Such removed dust, which contains usable calcium oxide, is often dumped in waste dumps, requiring environmental management, or disposed of off-site at a cost. Due to its relatively low commercial value and variable lime content it is difficult to sell this form of calcium oxide, at least the entire production thereof by a typical large lime factory, as an article of commerce, for example, such as lime used in agricultural applications.

The fact that calcium oxide is soluble in water, albeit only sparingly so, causes such dust stockpiles and dumps to constitute a potential environmental problem. Rain falling on such dumps may cause some of the calcium oxide to be dissolved, and this may lead to a run off stream of which the pH would typically exceed a value of 10. The release of such a solution in large quantities may in certain circumstances have disastrous effects on the underground water and/or surface water to which the run off stream is drained. Ground water problems are also potentially created by dumping such dust in quarries or worked out mines where it could come into contact with a rising water table.

A further environmental problem resulting from such stockpiles is that of windblown dust. The use of vegetation as a counter-measure is usually unsuccessful owing to the growing conditions.

Lime kilns also present an environmental issue in view of the large quantity of the greenhouse gas, carbon dioxide, which is generated during the production of lime. In some countries, legislation imposing a tax on emissions of carbon oxide has already been enacted or is being considered, thus imposing an additional environmental cost on the production of lime.

The applicants have now devised a process for addressing the aforementioned remaining environmental issues by utilising the waste material produced during the calcination of limestone in a novel manner to produce calcium carbonate as the end product which, at least, is environmentally less harmful than calcium oxide. The process consumes at least part of the normal waste products of lime production, namely dust which is rich in calcium oxide and carbon dioxide rich flue gas.

Some aspects of the process of the present invention involve chemical procedures which are known per se. The specific sequential methodology and the unique combination of procedures are, however, to the best of the applicants' knowledge, not known as such.

The process of the invention, in one of its applications provides a method of producing precipitated calcium carbonate which method has the added benefit of the potential for turning environmentally harmful waste materials into a source of revenue. This benefit arises from the considerations set out below.

Calcium carbonate is used in a variety of applications and commands a higher value as the level of purity is raised.

Despite the relative abundance of natural calcium carbonate, the chemically precipitated product is a relatively expensive in pure form.

### OBJECT OF THE INVENTION

It is thus an object of the present invention to provide a new method for producing precipitated calcium carbonate from a source material containing calcium oxide and particularly the application of such method to a source material which is a waste product of an industrial process, such as a process for the calcination of limestone to produce lime. According to a further object, the invention seeks to utilise carbon dioxide from the lime kiln exhaust gas. Carbon dioxide from other industries could however also be used as the gas source.

### STATEMENTS OF THE INVENTION

According to the present invention there is provided a method of reducing the detrimental environmental impact of an industrial plant which produced or produces a product selected from the group consisting of calcium oxide, also known as lime, and carbon dioxide gas, the method comprising the step of forming an environmentally less detrimental composition from such product which composition comprises predominantly calcium carbonate.

The detrimental dust containing calcium oxide may in one form of the invention be stockpiled but the invention is particularly, though not exclusively aimed at processes carried out at plants where it is being produced as part of an ongoing production process.

The method of the invention by which dust containing calcium oxide is converted to a less detrimental composition may involve the steps of:

(a) slaking the dust containing calcium oxide in water to obtain a composition containing hydrated lime;

(b) optionally, and if present, separating at least some of the larger unreacted particles from the hydrated lime composition to obtain a hydrated lime composition that is substantially lower in unreacted solids content;

(c) mixing the hydrated lime composition with ammonium nitrate thereby to convert the hydrated lime into a calcium stock solution containing calcium, ammonium and nitrate ions;

(d) optionally, and if present, separating at least some of any undissolved solid particles from the calcium stock solution to obtain a substantially solids free calcium stock solution;

(e) contacting the calcium stock solution with the carbon dioxide, preferably after scrubbing the carbon dioxide gas to render it substantially solids free and preferably also substantially free of sulphur oxide gasses, thereby to cause at least some of the carbon dioxide to react with at least some of the calcium ions in the calcium stock solution, and thus to cause calcium carbonate to be formed and to precipitate from a mother liquor containing ammonium and nitrate ions in solution;

(f) separating the precipitated calcium carbonate from the mother liquor; and

(g) recycling the mother liquor from step (e) as a feed of ammonium nitrate solution utilised in step (c) identified above.

In a preferred form of the present invention there is provided a method of reducing the environmental impact of an industrial plant producing a dusty gaseous stream of which the components include dust containing calcium oxide and carbon dioxide gas, the method comprising the formation of an environmentally less detrimental composition comprising predominantly calcium carbonate from the calcium oxide containing dust and the carbon dioxide, and involving the steps of:

(a) separating the dust and the gas into a predominantly solids fraction and a predominantly gaseous fraction;

(b) slaking the predominantly solids fraction in water to obtain a composition containing hydrated lime;

(c) optionally, and if present, separating at least some of the larger unreacted particles from the hydrated lime composition to obtain a hydrated lime composition that is substantially lower in unreacted solids content;

(d) mixing the hydrated lime composition with ammonium nitrate thereby to convert the hydrated lime into a calcium stock solution containing calcium, ammonium and nitrate ions;

(e) optionally, and if present, separating at least some of any undissolved solid particles from the calcium stock solution to obtain a substantially solids free calcium stock solution;

(f) optionally, scrubbing the predominantly gaseous fraction obtained in step (a) to remove, if present, at least some of any solid particles which may be present in the predominantly gaseous fraction, to obtain a substantially solids free gaseous fraction and also to remove sulphur oxides present in the gas stream;

(g) contacting the calcium stock solution with the predominantly gaseous fraction thereby to cause at least some of the carbon dioxide in the gaseous fraction to react with at least some of the calcium ions in the calcium stock solution, thereby to cause calcium carbonate to be formed and to precipitate from a mother liquor containing ammonium and nitrate ions in solution;

(h) separating the precipitated calcium carbonate from the mother liquor; and

(i) recycling the mother liquor from step (h) as a feed of ammonium nitrate solution utilised in step (d) identified above.

Those familiar with the slaking of lime in water will understand that as the calcium hydroxide resulting from the reaction between calcium oxide and water is only sparingly soluble in water, the resultant slaked lime composition is unlikely to be a solution but will in most cases be in the nature of a gelatinous mass. Depending on the purity of the dust containing the calcium oxide, and the nature, such as low water solubility of the contaminants which are present therein, the composition may be more in the nature of a slurry than a gel. All these variants are intended to be incorporated in the term “composition” selected to identify that product.

In a preferred application of the invention it is considered to be advantageous to carry out the optional scrubbing step identified as step (f). That step is furthermore preferably carried out by scrubbing the gaseous fraction by sparging it through a quantity of the calcium stock solution derived from step (d) or (e) identified above to a pH of 7.0 to 7.2. The calcium stock solution may include solids separated from such calcium stock solution in accordance with the optional step (e) identified above.

The contacting of the calcium stock solution with the predominantly gaseous fraction is preferably done for the purpose of obtaining at least some of the precipitated calcium carbonate in the form of high purity calcium carbonate. It is consequently a preferred application of the invention to incorporate at least the optional step (c), but more preferably also the optional step (e), as well as optional step (f), most preferably in the manner elaborated upon above, in the execution of the method of the invention.

The separations in optional steps (e) and (f) may for operational cost considerations simply involve the use of settling tanks which may preferably be fitted with slow stirrers and/or settler boxes and/or any other devices known in the trade to be useful to promote solid/liquid separation.

In the preferred form of the invention the hydrated lime composition with a low undissolved solids content is prepared in a commercial slaker or hydrator.

The step of contacting the calcium stock solution with the gaseous fraction may be carried out in any convenient reactor arrangement. It is however preferred in one embodiment of the invention to perform that step in a vertically extending tubular reactor by the steps of

feeding carbon dioxide into the reactor through an inlet by which the carbon dioxide is dispersed and which is disposed at or near the upper extremity of the reactor;

feeding a solution containing calcium ions and nitrate ions into the reactor through an inlet disposed at or near the lower extremity thereof;

providing a collector intermediate the upper and lower inlets of the reactor, which collector is functionally associated with an outlet adapted for use in withdrawing precipitated calcium carbonate collected thereby;

and, optionally feeding air into the reactor at a position at or near the lower inlet thereby to cause an updraught in the reactor thereby to carry calcium ions towards the carbon dioxide gas inlet.

In a preferred form of the invention, however, the source of the calcium oxide is a waste material containing a dust rich in calcium oxide such as the dust from the electrostatic precipitators or other dust removing equipment associated with the lime kilns.

The separation of the slurry into an undissolved solids fraction and a calcium ion containing solids free solution may be carried out by any convenient method such as filtration or settling. In this step of the method of the invention any suitable filter aids or settling enhancers may be used.

The precipitation phase of the process according to the invention, in which the calcium ion solution is intimately contacted with carbon dioxide gas, may be carried out in any convenient manner.

Preferably, however, the precipitation is effected by sparging the calcium ion solution with the conditioned carbon dioxide. The sparging process is further preferably controlled to result in a slow precipitation of the calcium carbonate.

The calcium ion solution from the slaking, washing and filtration steps of the process preferably has a pH of more than 11.5 and the contact of this solution with the conditioned carbon dioxide is preferably carried on until, and terminated when, the pH of the solution is reduced to between 7.0 and 7.2

The precipitated calcium carbonate is separated from the mother liquor by any convenient method and preferably by filtration. The mother liquor may in turn be re-used for slaking a fresh supply of feedstock source of calcium oxide.

It will be seen that the method of the present invention can be used either as a batch process or as a continuous process.

The advantages of this process over existing commercial and proposed processes is that it is simple and inexpensive to operate in that it does not require a costly stainless steel plant to operate as compared to some other processes in which highly corrosive products are used or produced. It also does not feature any high energy input requirements or complex control instrumentation. The process is also environmentally friendly in that it consumes a waste product in the form of dust-laden carbon dioxide and precipitator dust and does not give rise to any hazardous effluent. The process design also permits the process to be run in a cascade fashion whereby the calcium solubilisation and filtration step may be repeated on the feed material as often as the nature of the feed material may require for optimal extraction of calcium.

### DESCRIPTION OF THE DRAWINGS

In the accompanying drawings:

FIG. 1 is a flow sheet illustrating a first embodiment of the process according to the invention;

FIG. 2 is a flow sheet illustrating a second embodiment of the process according to the invention.

### ILLUSTRATIVE EXAMPLES OF THE INVENTION

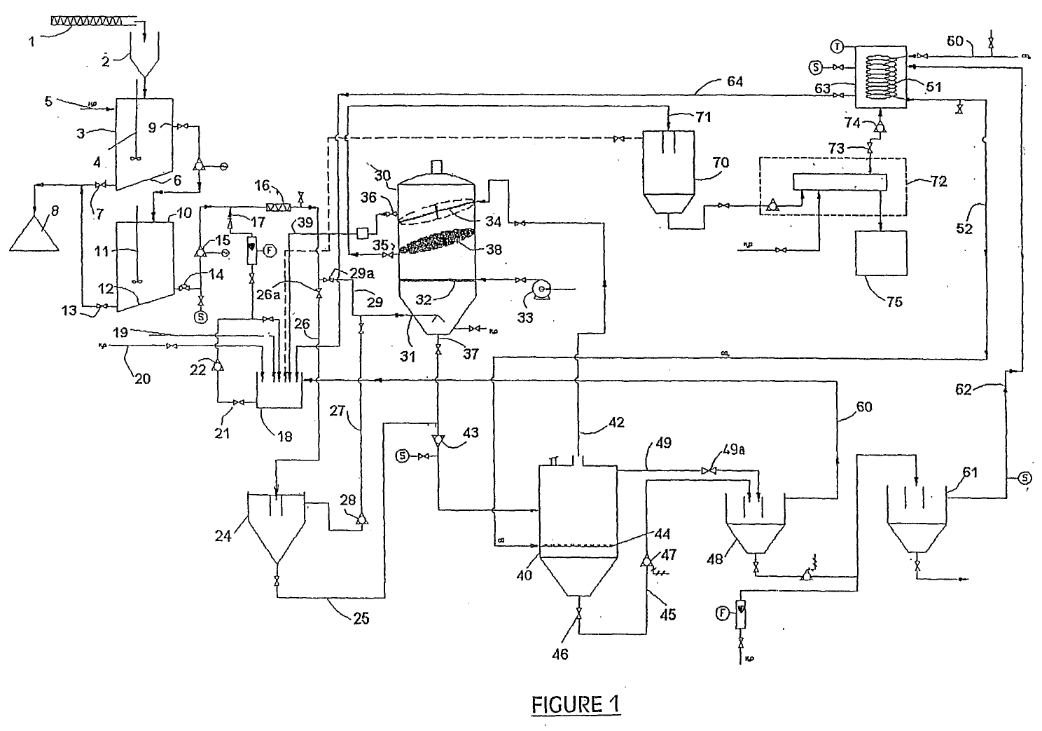

The invention will now be illustrated with reference to the accompanying two flow sheets. The flow sheets are only schematic representations of the various components used in the process and no components shown therein should be seen to be a realistic pictorial representation of any element to be used in the process. While many of the components, processes and sequences are common to the two processes represented by the respective flow sheet, it is considered convenient to provide two separate descriptions each covering the entire process represented by the respective flow sheets. This illustrative description deals first with the process illustrated in FIG. 1 and in that regard the production of a clear calcium stock solution will first be described.

Precipitated dust collected from the gas cleaning plant of a conventional lime kiln is shown in the flow sheet to be conveyed via a screw conveyer 1 into a kiln dust feed hopper 2 from whence it is fed, through a suitable control mechanism, in batch-wise fashion into a slaker tank 3 which is fitted with a stirrer 4. Water is fed into the slaker tank 3 through a line indicated at 5.

The slaker floor 6 is inclined to allow for easier removal of unreacted particles in the slaked slurry which are allowed to settle on the floor 6 of the slaker tank during the residence period of the hydrated lime gel in tank 3. Such precipitated grit may be removed via a valve 7 to a grit removal dump indicated at 8.

From a position higher up on the slaker wall a conduit fitted with a valve 9 is provided through which the slaked gel is removed and fed into a second tank, referred to herein as the slurry feed tank which is of similar design to the slaker tank which slurry feed tank is indicated by reference numeral 10. The slurry feed tank 10 is likewise fitted with a stirrer 11. Further settling of any solids which may have been carried forward from tank 3 takes place in tank 10 and for this purpose tank 10 also features an inclined floor 12 to allow for easier withdrawal of any settled grit via a valve 13 to the removal dump 8.

A valve for drawing off the slaked lime slurry from tank 10 is provided and indicated at 14.

The slurry is fed via a pump 15 to a static mixer 16 in which the slurry is thoroughly mixed with a clear solution of ammonium nitrate in water, which is prepared and supplied as described below.

The ammonium nitrate solution is stored in a buffer tank indicated at 18 by the introduction into the buffer tank 18 of ammonium nitrate through a valve controlled line 19 and water through line 20. The buffer tank has various other inflows of ammonium nitrate either at the same or at different concentrations as the make-up ammonium nitrate as will be described in greater detail below.

The ammonium nitrate solution is withdrawn from the buffer tank 18 through conduit 17 fitted with valve 21 and pump 22. It is mixed with the hydrated lime slurry in the mixer 16 to form a calcium stock solution which also contains ammonium and nitrate ions. The stock solution so prepared is fed into a calcium stock solution feed tank 24 which is fitted with a settler box to allow for the gravitational settling of any insolubles. Tank 24 is provided with an inverted conical base to facilitate the withdrawal of any settled solids from the calcium stock solution tank 24 via conduit 25 which is operationally connected to pump 43 as described in greater detail below.

Clear calcium stock solution may be withdrawn from the upper regions of feed tank 24 via a conduit 27 with the aid of pump 28 and fed into a reactor 30.

In the flow diagram conduit 26 is shown to be capable of being short-circuited via line 29 and with the aid of valves 26a and 29a so as to divert the calcium stock solution to be fed directly to the reactor. This short circuit may be used in the event of it being found that the calcium stock solution obtained from the static mixer 16 is sufficiently clear to allow one to bypass the calcium stock solution feed and settling arrangement of tank 24.

Calcium stock solution drawn from the conical section of calcium stock solution feed tank 24 and containing such solids as may have been carried forward is fed into a neutraliser/scrubber shown at 40 and to be discussed in greater detail below.

The treatment of the carbon dioxide gas stream will now be described.

CO₂ gas collected from the flue of a lime plant, and still at an elevated temperature, is fed via gas line 50 to a heat exchanger 51 where the heat is utilised to condition the ammonium nitrate solution as will be described shortly.

The cooled gas, still entraining some dust not removed by the precipitators, is introduced through line 52 into the neutraliser/scrubber 40. All solids in the gas are thereby removed by contact with the solution in the neutraliser/scrubber 40. The clean gas is fed through line 42 to a sparging arrangement 34 located inside the reactor 30.

In the neutraliser/scrubber 40 there also occurs a chemical reaction apart from the physical removal of the dust particles from the carbon dioxide stream fed into via conduit 52. The liquid component in the neutraliser/scrubber is supplied from two sources. Firstly, such liquid component is drawn from the calcium stock solution feed/settler tank 24 from where it is taken from the bottom of the conical base of that tank and fed via pump 43 to the neutraliser/scrubber. This feed stream contains, in solution, calcium (Ca⁺⁺), nitrate (NO₃⁻) and ammonia (NH₄⁺), ions and some undissolved iron and magnesium oxides which settled out in tank 24. Bringing the carbon dioxide stream through sparger 44 into contact with this solution causes the formation of calcium carbonate and the precipitation thereof from the liquid phase.

This precipitation causes the formation of what can be termed as “impure calcium carbonate”. The calcium carbonate so formed is fed through conduit 45 fitted with valve 46 and pump 47 to a first settler tank 48. The overflow from the neutraliser/scrubber is likewise fed into settler tank 48 via conduit 49 fitted with a valve 49a. In settler tank 48 the solids are settled out of the solution which now comprises predominantly an ammonium nitrate solution of substantially the same concentration as was originally drawn from the buffer tank 18 and is accordingly fed back to the buffer tank 18 via line 60. The settled calcium carbonate is withdrawn from the settler tank and fed into a second settler tank 61 where it is washed with water with the object of recovering therefrom substantially all of the nitrate values. The wash water accordingly comprises a nitrate solution in which nitrates are present in a lower concentration than that of the nitrate solution in the buffer tank 18. It is accordingly fed via conduit 62 to the ammonium nitrate conditioning tank 63 where the heat of the CO₂ gas fed into the heat exchanger 51 is utilised to bring the ammonium nitrate solution to the same concentration as that of the buffer tank and such concentrated ammonium nitrate solution is then fed through conduit 64 back to the buffer tank 18.

It is regarded that the aforementioned nitrate recovery and recycling system forming part of the present invention is of central importance to the commercial success of the process according to the present invention.

The reactor 30 will now be described in greater detail.

The reactor 30 comprises an elongated, tubular unit in vertical disposition. It provides at or near a lower end thereof an inlet 31 through which conduit 27, alternatively conduit 29, feeds clear calcium stock solution into the lower part of the reactor 30 thus creating a high concentration of calcium ions in the lower part of the reactor 30.

Disposed in the lower half of the reactor there is provided an air sparger indicated at 32. This is connected to a blower 33 which supplies atmospheric air to the reactor 30 which is filled with the calcium stock solution. This air sparger is used in operating the plant to introduce air into the elongated tubular reactor thereby to assist in the dispersion of the calcium ions fed into the reactor via inlet 31 to drive such calcium ions upwardly.

At the upper end of the reactor 30 a carbon dioxide gas inlet is provided in a sparger arrangement 34 to allow gas rich in carbon dioxide to be fed into the solution disposed inside the reactor. The air introduced into the reactor serves also to strip carbon dioxide out of the liquid in the reactor.

Intermediate these spargers is located a perforated plate 38 which is set at an incline in the reactor and which serves several functions. First of all it assists in the breaking up of the air bubbles fed through the sparger 32 and secondly it serves as a collector plate for precipitate formed by the contact between the calcium ions driven upwardly by the air being blown through the sparger 32, and the carbon dioxide gas being introduced into the solution via the sparger 34. A take-off valve 35 is provided at the lower end of the perforated plate, and an outlet valve 36 is also provided at approximately the level of the carbon dioxide sparger 30 for obtaining samples for pH control. The flow through the reactor 30 is balanced so that the rate at which calcium rich stock solution is fed into the reactor via inlet 31 is balanced by the liquid off-take through valve 35. There is an intermittent draw-off from the outlet 37 from the zone of the reactor where impure calcium carbonate will form and collect. This impure product is recycled into the neutraliser/scrubber 40 and combined there with the impurities withdrawn from the feed settler 24.

The precipitated calcium carbonate withdrawn through valve 35 is fed to a product settlement tank 70 via conduit 71. The settled product is filtered and washed in a conventional arrangement shown at filter 72. The filtrate is returned to the ammonium nitrate buffer tank. The wash water is returned to the ammonium nitrate conditioning tank 63 via valve 73 and pump 74 and the filtered product is collected at 75, ready to be bagged and shipped.

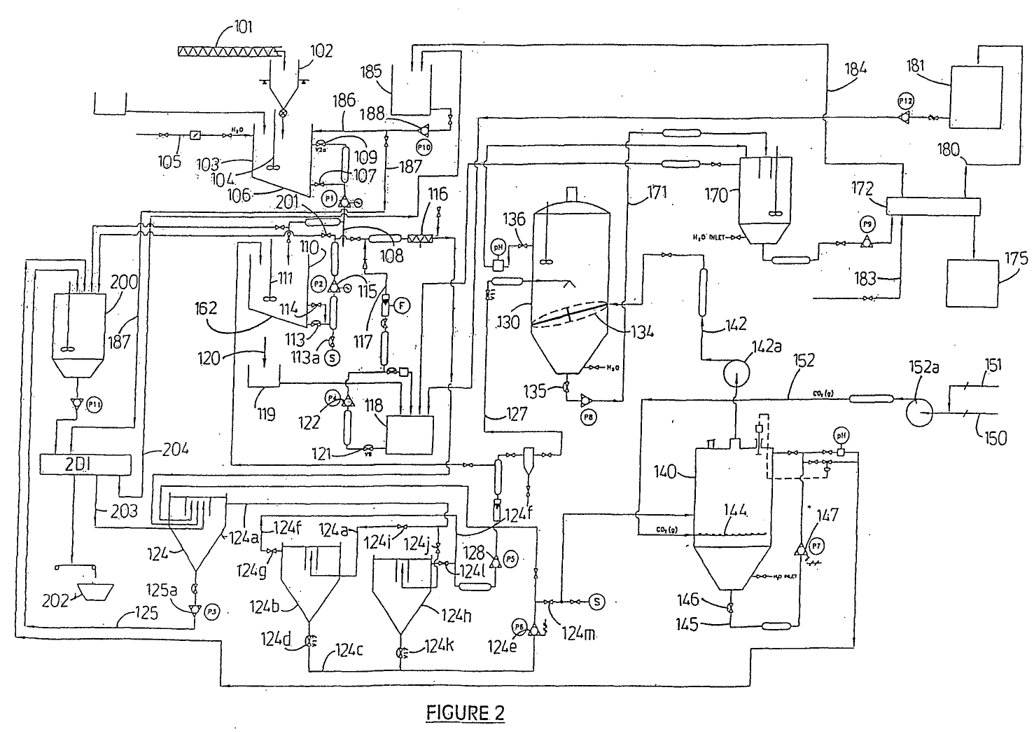

Referring now to the process illustrated in FIG. 2 the production of a clear calcium stock solution will again first be described.

Precipitated dust collected from the gas cleaning plant of a conventional lime kiln is shown in the flow sheet to be conveyed via a screw conveyer 101 into a kiln dust feed hopper 102 from whence it is fed, through a suitable control mechanism, in batch-wise fashion into a slaker tank 103 which is fitted with a stirrer 104. Water is fed into the slaker tank 103 through a line indicated at 105.

The slaker floor 106 is inclined to allow for easier removal of undissolved particles in the slaked slurry which are allowed to settle on the floor 106 of the slaker tank during the residence period of the hydrated lime gel in tank 103. Such precipitated grit may be removed via a valve 107 to a waste concentration tank 200 via the waste line indicated at 108 and waste control valve 201.

From a position higher up on the slaker wall a conduit fitted with a valve 10 is provided through which slaked gel is removed and fed into a second tank, referred to herein as the slurry feed tank which is of similar design to the slaker tank and which slurry feed tank is indicated by reference numeral 110. The slurry feed tank 110 is likewise fitted with a stirrer 111. Further settling of any solids which may have been carried forward from tank 103 takes place in tank 110 and for this purpose tank 110 also features an inclined floor 112 to allow for easier withdrawal of any settled grit via a valves 113 and 201 to the waste concentration tank 200.

A valve for drawing off substantially clear slaked lime slurry from tank 110 is provided and indicated at 114.

The slaked lime slurry is fed via a pump 115 to a static mixer 116 in which the slurry is thoroughly mixed with a clear solution of ammonium nitrate in water, which is prepared and supplied as described below.

The ammonium nitrate solution is stored in a buffer tank indicated at 118 by the introduction into the ammonium nitrate buffer tank 118 of ammonium nitrate solution from an ammonium nitrate make-up tank 119 in which ammonium nitrate prills are dissolved in water introduced through line 120. The buffer tank 118 has various other inflows of ammonium nitrate either at the same or at different concentrations as the make-up ammonium nitrate as will be described in greater detail below.

The ammonium nitrate solution is withdrawn from the buffer tank 118 through conduit 117 fitted with valve 121 and pump 122. It is mixed with the hydrated lime slurry in the mixer 116 to form a calcium stock solution which also contains ammonium and nitrate ions. The stock solution so prepared is fed into a calcium stock solution feed tank 124 which is fitted with a settler box to allow for the gravitational settling of any further insolubles. Tank 124 is provided with an inverted conical base to facilitate the withdrawal of any settled solids from the calcium stock solution feed tank 124 via conduit 125 and by means of pump 125a, and is fed to waste concentration tank 200.

Relatively clear calcium stock solution is withdrawn from the upper regions of calcium stock solution feed tank 124 via a conduit 124a and introduced into a similarly constructed calcium stock solution feed tank 124b allowing further clarification of the solution through settling. Settled solids are removed from the conical base of tank 124b via conduit 124c and valve 124d and pumped by pump 124e either into calcium stock solution feed tank 124 via its settling box or into a scrubber 140 as described in greater detail below as controlled by means of valves 124m and 124n. The clear overflow is withdrawn via conduit 124f and valve 124g and is pumped with the aid of pump 128 and fed into a reactor 130 as described in greater detail below. An optional third calcium stock solution feed tank 124h, again of the same construction, may be provided. It is optionally fed from the relatively clear overflow of tank 124 as controlled by valves 124i and 124j. The conical base of this tank 124h is in fluid communication with conduit 124c via valve 124k and its overflow is in fluid communication with line 124f via valve 124l.

Calcium stock solution drawn from the conical section of calcium stock solution feed tank 124b and containing such solids as may have been carried forward is fed into a neutraliser/scrubber shown at 140 which is discussed in greater detail below.

The treatment of the carbon dioxide gas stream in this embodiment of the invention will now be described.

CO₂ gas collected from the flue of a lime plant is fed via gas line 150. An air line 151 for feeding air into the system during start-up and shut-down procedures is also provided.

The gas, still entraining some dust not removed by the precipitators, is introduced through line 152 with the aid of a blower 152a into the neutraliser/scrubber 140. All solids in the gas are thereby removed by contact with the solution in the neutraliser/scrubber 140. The clean, scrubbed gas is fed through line 142 with the aid of a blower 142a to a sparging arrangement 134 located inside the reactor 130. The sparger comprises a ring-shaped tube fitted with two intersecting and diametrically extending tubes which are provided with upwardly open openings and with an inlet extending through the wall of the tubular reactor 130.

In the neutraliser/scrubber 140 there also occurs a chemical reaction apart from the physical removal of the dust particles from the carbon dioxide stream fed into via conduit 152. The liquid component in the neutraliser/scrubber is supplied from two sources. Firstly, such liquid component is drawn from the calcium stock solution feed/settler tank 124b (and/or 124h, if employed) from whence it is taken from the bottom of the conical base of that tank and fed via pump 124e to the neutraliser/scrubber. This feed stream contains, in solution, calcium (Ca⁺⁺), nitrate (NO₃⁻) and ammonia (NH₄⁺), ions and some undissolved iron and magnesium oxides which settled out in tank 124b (and/or 124h). Bringing the carbon dioxide stream through spargers 144 provided in scrubber 140 into contact with this solution causes the formation of calcium carbonate and the precipitation thereof from the liquid phase.

This precipitation causes the formation of what can be termed as “impure calcium carbonate”. The impure calcium carbonate so formed is optionally fed through conduit 145 fitted with valve 146 and pump 147 to the waste concentration and ammonia recovery tank 200 or recycled into the scrubber depending on whether the pH of the solution so withdrawn had reached a predetermined value, which is generally considered to be not below 7, i.e. the pH of the scrubbing liquid in the scrubber should not drop into the acidic range as it will then be less effective as a scrubbing liquid for being unable for example to scrub SO₂ from the gas stream. The scrubber is further fitted with a level control to ensure that an adequate head of liquid is maintained to ensure effective scrubbing and excess liquid is fed to the waste concentration and ammonia recovery tank 200.

In the waste concentration settler tank 200 the solids are settled out of the solution and passed through a belt filter 201. The solid filter cake so obtained is disposed of as relatively inert carbonates as illustrated at 202. The filter cake is thoroughly washed with wash water derived from the product filtration phase as described below. The filtrate obtained from the filter phase of this separation phase is introduced into the calcium solution feed tank 124 via conduit 203, while the wash water is recycled to the wash water make up tank described below via conduit 204.

It is regarded that the aforementioned nitrate recovery and recycling system forming part of the present invention is of central importance to the commercial success of the process according to the present invention.

The reactor 130 will now be described in greater detail.

The reactor 30 comprises an elongated, tubular unit in vertical disposition. It provides at or near the mid-zone thereof an inlet 131 through which conduit 127 feeds clear calcium stock solution into the central zone of the reactor 130 thus creating a high concentration of calcium ions in the central zone part of the reactor 130.

In the lower half of the reactor 130 a carbon dioxide gas inlet is provided in a sparger arrangement 134 to allow gas rich in carbon dioxide to be fed into the solution disposed inside the reactor via conduit 142 and with the aid of blower 142a.

The sparging of the clear calcium feed solution introduced into the reactor 130 via inlet 131 with the clean scrubbed CO2-rich gas introduced via sparger 134 gives rise to the formation of calcium carbonate which settles in the frusto-conical base of reactor 130. From the base the settled calcium carbonate is continuously withdrawn. A take-off valve 135 is provided at the lower end of the reactor. A second outlet valve 136 is provided at a level above the primary reaction zone for the pH control sample. The flow through the reactor 130 is balanced so that the rate at which calcium rich stock solution is fed into the reactor via inlet 131 is balanced by the liquid off-take through the outlet 135 in which zone of the reactor precipitated calcium carbonate product, obviously still in mother liquor containing ammonium and nitrate ions collects. The flow is also controlled with reference to the pH of the solution in the reactor 130 as monitored by means of a pH meter 136a associated with valve 136. The pH of the solution in the reactor is required to stay above 7 for ideal operation of the process.

The precipitated calcium carbonate withdrawn through valve 135 is fed to a product settlement tank 170 via conduit 171. The settled product is filtered and washed in a conventional arrangement shown at filter 172. The filtrate separated from the product is fed via conduit 180 to a filtrate tank 181 from whence it is pumped on demand by pump 182 to the ammonium nitrate buffer tank 118. Wash water fed to the filter via conduit 183 and employed to wash the filtered product on filter 172 is fed via conduit 184 to a recycled water tank 185 from which water is drawn via conduit 186 to slake the lime in slaker 103 or via conduit 187 for the purpose of washing the filtered solids on waste filter 201. Both these feeds are done with the aid of pump 188. The spent wash water from filter 201 is recycled via conduit 204 to tank 185. The filtered product is collected at 175, ready to be bagged and shipped.

1. A method of reducing the environmental impact of an industrial plant which produced or produces a product selected from the group consisting of dust containing calcium oxide and carbon dioxide gas, the method comprising the step of forming an environmentally less detrimental composition from such product which composition comprises predominantly calcium carbonate.

2. The method of claim 1 in which the less detrimental composition is produced by
(a) slaking the dust containing calcium oxide in water to obtain a composition containing hydrated lime;
(b) optionally, and if present, separating at least some of the unreacted particles from the hydrated lime composition to obtain a hydrated lime composition that is substantially lower in solids content;
(c) mixing the hydrated lime composition with an aqueous solution of ammonium nitrate thereby to convert the hydrated lime into a calcium stock solution containing calcium, ammonium and nitrate ions;
(d) optionally, and if present, separating at least some of any undissolved solid particles from the calcium stock solution to obtain a substantially solids free calcium stock solution;
(e) contacting the calcium stock solution with carbon dioxide, preferably after scrubbing the carbon dioxide gas to render it substantially solids free and preferably also substantially free of sulphur oxide gasses, thereby to cause at least some of the carbon dioxide to react with at least some of the calcium ions in the calcium stock solution, and thus to cause calcium carbonate to be formed and to precipitate from a mother liquor containing ammonium and nitrate ions in solution;
(f) separating the precipitated calcium carbonate from the mother liquor; and
(g) recycling the mother liquor from step (e) as a feed of ammonium nitrate solution utilised in step (c) identified above.

3. A method of reducing the environmental impact of an industrial plant producing a dusty gaseous stream of which the components include dust containing calcium oxide and carbon dioxide gas, the method comprising the steps of forming an environmentally less detrimental composition from the dust which contains calcium oxide and the carbon dioxide comprising predominantly calcium carbonate by:
(a) separating the dust and the gas into a predominantly solids fraction and a predominantly gaseous fraction;
(b) slaking the predominantly solids fraction in water to obtain a composition containing hydrated lime;
(c) optionally, and if present, separating at least some of any undissolved particles from the hydrated lime composition to obtain a substantially solids free hydrated lime composition;
(d) mixing the hydrated lime composition with an aqueous solution of ammonium nitrate thereby to convert the hydrated lime into a calcium stock solution containing calcium, ammonium and nitrate ions;
(e) optionally, and if present, separating at least some of any undissolved solid particles from the calcium stock solution to obtain a substantially solids free calcium stock solution;
(f) optionally, scrubbing the predominantly gaseous fraction obtained in step (a) to remove, if present, at least some of any solid particles which may be present in the predominantly gaseous fraction, to obtain a substantially solids free gaseous fraction which is preferably also substantially free of sulphur oxide gasses;
(g) contacting the calcium stock solution with the predominantly gaseous fraction thereby to cause at least some of the carbon dioxide in the gaseous fraction to react with at least some of the calcium ions in the calcium stock solution, thereby to cause calcium carbonate to be formed and to precipitate from a mother liquor containing ammonium and nitrate ions in solution;
(h) separating the precipitated calcium carbonate from the mother liquor; and
(i) recycling the mother liquor from step (h) as a feed of ammonium nitrate solution utilised in step (d) identified above.

4. The method of claim 2 or 3 wherein the optional scrubbing step is carried out and wherein the scrubbing of the gaseous fraction is done by sparging it through a quantity of the calcium stock solution identified above.

5. The method of claim 3 wherein the contacting of the calcium stock solution with the predominantly gaseous fraction is performed for the purpose of obtaining at least some of the precipitated calcium carbonate in the form of high purity precipitated calcium carbonate and wherein the optional steps (c), but more preferably also the optional step (e), as well as optional step (f), are thus performed in the execution of the method.

6. The method of claim 2 or 3 wherein the separations in optional steps involve the use of settling tanks which are preferably fitted with slow stirrers and/or settler boxes and/or any other devices known in the trade to be useful to promote solid/liquid separation.

7. The method of claim 2 or 3 wherein the substantially solids free hydrated lime composition is prepared in a conventional commercial slaker or hydrator.

8. The method of claim 2 or 3 wherein the step of contacting the calcium stock solution with the gaseous fraction is carried out in a vertically extending tubular reactor by the steps of feeding carbon dioxide into the reactor through an inlet by which the carbon dioxide is dispersed and which is disposed at or near the upper extremity of the reactor;
feeding a solution containing calcium ions and nitrate ions into the reactor through an inlet disposed at or near the lower extremity thereof;
providing a collector intermediate the upper and lower inlets of the reactor, which collector is functionally associated with an outlet adapted for use in withdrawing precipitated calcium carbonate collected thereby;
and, optionally feeding air into the reactor at a position at or near the lower inlet thereby to cause an updraught in the reactor thereby to carry calcium ions towards the carbon dioxide gas inlet.

9. The method of claim 1, 2 or 3 wherein the source of the calcium oxide is a waste material containing lime such as the dust from the electrostatic precipitators or other dust removing equipment associated with the lime kilns.

10. The method of claim 2 or 3 wherein the separation of the slurry into an undissolved solids fraction and a calcium ion containing solids free solution is carried out by settling.

11. The method of claim 2 or 3 wherein the precipitation is effected by sparging the calcium ion solution with the conditioned carbon dioxide emerging from the scrubbing.

12. The method of claim 2 or 3 wherein the calcium ion solution has a pH of more than 11.5 and the contact of this solution with the conditioned carbon dioxide is preferably carried on until, and terminated when the pH of the solution is reduced to between 7.0 and 7.2.
